(19) United States
(12) Patent Application Publication
(10) Pub. No.: US 2018/0024629 A1
(43) Pub. Date: Jan. 25, 2018

(54) CONTENT ACQUIRING METHOD AND APPARATUS, AND USER EQUIPMENT

(71) Applicant: BEIJING ZHIGU RUI TUO TECH CO., LTD., BEIJING (CN)

(72) Inventor: ZHENGXIANG WANG, BEIJING (CN)

(21) Appl. No.: 15/540,603

(22) PCT Filed: Jan. 7, 2016
(86) PCT No.: PCT/CN2016/070334

§ 371 Date: Jun. 29, 2017

(30) Foreign Application Priority Data
Jan. 7, 2015 (CN) 201510007032.9

(51) Int. Cl. G06F 3/01; G06F 17/30

(52) U.S. Cl. CPC G06F 3/013; G06F 17/30873; G06F 17/3089; G06F 3/03543

(57) ABSTRACT

This application generally relates to content acquiring methods and apparatus, and user equipment. A content acquiring method disclosed herein comprises: determining a sight focus area of a user in a display interface; determining at least one link within the sight focus area in response to a moving direction of a cursor in the display interface towards the sight focus area; and acquiring at least one piece of content corresponding to the at least one link. Embodiments of this application provide solutions for content acquisition.

### RELATED APPLICATION

The present international patent cooperative treaty (PCT) application claims priority to and benefit of Chinese Patent Application No. 201510007032.9, filed on Jan. 7, 2015, and entitled “Content Acquiring Method and Apparatus, and User Equipment”, which is hereby incorporated into the present international PCT application by reference herein in its entirety.

### TECHNICAL FIELD

Embodiments of this application generally relate to the field of human computer interaction technologies, and in particular, to content acquiring methods and apparatus, and user equipment.

### BACKGROUND

Usually, when a network is not very stable or a network speed is slow, after clicking a web page link, a user may need to wait for a period of time before a web page corresponding to the web page link can be opened. This negatively affects user experience.

### SUMMARY

In view of this, one objective of embodiments of this application is to provide a solution for content acquisition.

To achieve the foregoing objective, according to a first aspect of an embodiment of this application, a content acquiring method is provided, comprising:

determining a sight focus area of a user in a display interface;

determining at least one link within the sight focus area in response to a moving direction of a cursor in the display interface towards the sight focus area; and

acquiring at least one piece of content corresponding to the at least one link.

To achieve the foregoing objective, according to a second aspect of an embodiment of this application, a content acquiring apparatus is provided, comprising:

an area determining module, configured to determine a sight focus area of a user in a display interface;

a link determining module, configured to determine at least one link within the sight focus area in response to a moving direction of a cursor in the display interface towards the sight focus area; and

an acquiring module, configured to acquire at least one piece of content corresponding to the at least one link.

To achieve the foregoing objective, according to a third aspect of an embodiment of this application, a user equipment is provided, comprising: a display screen, configured to display a display interface; and a content acquiring apparatus described above.

At least one technical solution of the foregoing technical solutions has the following beneficial effects:

The embodiments of this application, through determining a sight focus area of a user in a display interface, determining at least one link within the sight focus area in response to a moving direction of a cursor in the display interface towards the sight focus area, and acquiring at least one piece of content corresponding to the at least one link, provide a solution of content acquisition, and pre-acquire content corresponding to the link before the user clicks the link, thereby accelerating opening of corresponding content after the user clicks the link. Moreover, the content is pre-acquired only when the conditions on the sight focus area and the moving direction of the cursor are both met, so as to reduce meaningless content pre-acquiring to some extent.

### BRIEF DESCRIPTION OF THE DRAWINGS

FIG. 1 is a schematic flowchart of an embodiment of a content acquiring method provided by this application;

FIG. 2 is a schematic structural diagram of Embodiment 1 of a content acquiring apparatus provided by this application;

FIG. 3A to FIG. 3D respectively illustrate schematic structural diagrams of an implementation manner of an embodiment as shown in FIG. 2;

FIG. 4 is a schematic structural diagram of Embodiment 2 of a content acquiring apparatus provided by this application;

FIG. 5 is a schematic structural diagram of an embodiment of a user equipment provided by this application; and

FIG. 6A and FIG. 6B respectively are schematic structural diagrams of an implementation manner of the embodiment as shown in FIG. 5.

### DETAILED DESCRIPTION

Specific implementation manners of this application are described in further detail below with reference to the accompanying drawings and embodiments. The following embodiments are intended to explain the present application, but not to limit the scope of the present application.

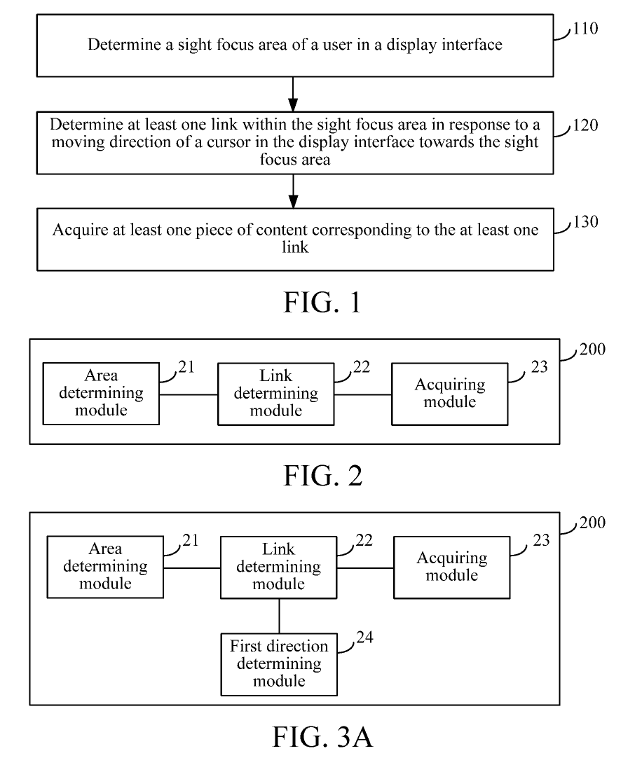

FIG. 1 is a schematic flowchart of an embodiment of a content acquiring method provided by an embodiment of this application. As shown in FIG. 1, this embodiment comprises the following steps:

110: Determine a sight focus area of a user in a display interface.

For example, steps 110 to 130 are performed by a content acquiring apparatus that is described in Embodiment 1 or Embodiment 2 of a content acquiring apparatus provided by this application. Optionally, the content acquiring apparatus is set in a user equipment in a form of hardware and/or software. The user equipment comprises but is not limited to any one of the following: a mobile phone, a notebook computer (laptop), a tablet, and the like.

In this embodiment, the sight focus area comprises: content that is focused by the sight of the user. Usually, the sight focus area is a part of the display interface.

In this embodiment, the sight focus area can be determined in multiple manners. For example, the content acquiring apparatus can trace the sight of the user through a sight tracing technology to determine the sight focus area.

120: Determine at least one link within the sight focus area in response to a moving direction of a cursor in the display interface towards the sight focus area.

In this embodiment, the cursor may be in various forms. Optionally, the cursor is an explicit cursor or an implicit cursor. When the cursor is an explicit cursor, the cursor may be in different shapes, such as an arrow shape and a hand shape. For example, the cursor is a mouse cursor, also known as a mouse pointer, optionally moving in the display interface with a movement of the mouse or a movement of a conductor on a touch panel. For another example, the cursor is a text cursor, optionally moving in a corresponding direction in the text of the display interface with a click of any direction key. Specifically, the direction key comprises but is not limited to any one of the following: “↑” key, “↓” key, “←” key, and “→” key.

In this embodiment, the moving direction of the cursor may be an instantaneous moving direction of the cursor, or a moving direction that is obtained according to a moving track of the cursor within a certain time frame.

In this embodiment, whether the moving direction of the cursor points towards the sight focus area usually relates to a current location of the cursor.

In this embodiment, the at least one link is one link or multiple links.

In this embodiment, optionally, if the moving direction of the cursor does not point toward the sight focus area, there may be no need to determine the at least one link within the sight focus area, and further, there may be no need to perform step 130.

130: Acquire at least one piece of content corresponding to the at least one link.

In this embodiment, each of the at least one link points to an address of a piece of content corresponding to the link.

In this embodiment, the at least one piece of content comprises at least one of the following: at least one web page, at least one application program, at least one document, at least one audio, at least one video, and at least one image.

In this embodiment, an objective of the acquiring at least one piece of content corresponding to the at least one link is to be able to open the at least one piece of content faster when a user subsequently needs it. Specifically, the acquiring may be implemented in multiple manners. Specifically, the acquiring at least one piece of content corresponding to the at least one link comprises: downloading the at least one piece of content to a local disk from an external device, or loading the at least one piece of content to a local memory, or loading the at least one piece of content to the local memory from the local disk.

The embodiments, through determining a sight focus area of a user in a display interface, determining at least one link within the sight focus area in response to a moving direction of a cursor in the display interface towards the sight focus area, and acquiring at least one piece of content corresponding to the at least one link, provide a solution for content acquisition, and pre-acquire content corresponding to the link before a user clicks the link, thereby accelerating opening of corresponding content after the user clicks the link. Moreover, the content is pre-acquired only when the conditions on the sight focus area and the moving direction of the cursor are both met, so that meaningless pre-acquiring is reduced to some degree.

The method embodiments are further described through the following optional implementation manners.

In the embodiments, there may be multiple human-computer interaction manners, that is, a user has multiple manners to control the cursor, specifically, controlling movement of the cursor.

In an optional implementation manner, a user controls the cursor through a mouse. In this implementation manner, optionally, before the determining at least one link within the sight focus area in response to a moving direction of a cursor in the display interface towards the sight focus area, the method further comprises:

determining the moving direction of the cursor in response to at least one mouse operation.

The at least one mouse operation refers to at least one operation to a mouse, comprising but not limited to: moving the mouse, rolling a wheel of the mouse, and the like.

In still another optional implementation manner, a user controls the cursor through touch control. In this implementation manner, optionally, before the determining at least one link within the sight focus area in response to a moving direction of a cursor in the display interface towards the sight focus area, the method further comprises:

determining the moving direction of the cursor in response to a movement of at least one conductor on a touch sensing apparatus.

The at least one conductor may be a limb of a user, such as a finger, or a capacitive pen.

Optionally, the touch sensing apparatus is a touch screen that presents the display interface.

Optionally, the touch sensing apparatus is a touch panel.

In still another optional implementation manner, a user controls the cursor through a body movement. In this implementation manner, optionally, before the determining at least one link within the sight focus area in response to a moving direction of a cursor in the display interface towards the sight focus area, the method further comprises:

determining the moving direction of the cursor in response to at least one body movement of the user.

Optionally, the at least one body movement comprises but is not limited to: at least one hand gesture.

In still another optional implementation manner, a user controls the cursor through a keyboard operation. In this implementation manner, optionally, before the determining at least one link within the sight focus area in response to a moving direction of a cursor in the display interface towards the sight focus area, the method further comprises:

determining the moving direction of the cursor in response to at least one keyboard operation.

The at least one keyboard operation refers to at least one operation to a keyboard, comprising but not limited to: clicking at least one direction key, and the like. Specifically, the at least one direction key comprises but is not limited to at least one of the following: “↑” key, “↓” key, “←” key, and “→” key.

In this embodiment, optionally, after the acquiring at least one piece of content corresponding to the at least one link, the method further comprises:

opening, in response to that one link in the at least one link is clicked, a piece of content corresponding to the link that has been acquired.

For example, if a piece of content corresponding to the link is a web page, the web page is opened in response to that the link is clicked; if a piece of content corresponding to the link is an application program, the application program is opened in response to that the link is clicked; if a piece off content corresponding to the link is a document, the document is opened in response to that the link is clicked; if a piece of content corresponding to the link is an audio, the audio is opened in response to that the link is clicked; if a piece of content corresponding to the link is a video, the video is opened in response to that the link is clicked; and if a piece of content corresponding to the link is an image, the image is opened in response to that the link is clicked.

Optionally, the opening a piece of content corresponding to the link that has been acquired comprises: displaying the piece of content corresponding to the link in the display interface. For example, if the piece of content corresponding to the link is a web page, the web page is displayed in the display interface in response to that the link is clicked.

In an application scenario of this embodiment, a user opens a browser and enters an image search page. After a key word is inputted, many thumbnails of many images appear in the display interface. Each thumbnail of each image actually is a link corresponding to the image. The user notices one thumbnail among many thumbnails. If the user wants to see an image corresponding to the thumbnail, during a process of moving the mouse, a content acquiring apparatus determines the sight focus area, that is an area where the thumbnail is located, of the user by using the method of this embodiment, determines the thumbnail within the sight focus area in response to a moving direction of a cursor in the display interface towards the sight focus area, and acquires an image corresponding to the thumbnail. Later, when the user clicks the thumbnail, the image corresponding to the thumbnail can be opened very quickly.

FIG. 2 is a schematic structural diagram of Embodiment 1 of a content acquiring apparatus provided by this application. As shown in FIG. 2, the content acquiring apparatus 200 comprises:

an area determining module 21, configured to determine a sight focus area of a user in a display interface;

a link determining module 22, configured to determine at least one link within the sight focus area in response to a moving direction of a cursor in the display interface towards the sight focus area; and an acquiring module 23, configured to acquire at least one piece of content corresponding to the at least one link.

In this embodiment, the content acquiring apparatus 200 is optionally set in a user equipment in a form of hardware and/or software. The user equipment comprises but is not limited any one of the following: a mobile phone, a notebook computer, a tablet, and the like.

In this embodiment, the sight focus area comprises: content that is focused by the sight of the user. Usually, the sight focus area is a part of the display interface.

In this embodiment, the area determining module 21 may use different methods to determine the sight focus area. For example, the content acquiring module 21 can trace the sight of the user through a sight tracing technology to determine the sight focus area.

In this embodiment, the cursor may be in various forms. Optionally, the cursor is an explicit cursor or an implicit cursor. When the cursor is an explicit cursor, the cursor has multiple shapes, such as an arrow shape and a hand shape. For example, the cursor is a mouse cursor, also known as a mouse pointer, optionally moving in the display interface with a movement of the mouse or a movement of a conductor on a touch panel. For another example, the cursor is a text cursor, optionally moving in a corresponding direction in the text of the display interface with a click of any direction key. Specifically, the direction key comprises but is not limited to any one of the following: “↑” key, “↓” key, “←” key, and “→” key.

In this embodiment, the moving direction of the cursor may be an instantaneous moving direction of the cursor, or a moving direction that is obtained according to a moving track of the cursor within a period of time.

In this embodiment, whether the moving direction of the cursor points towards the sight focus area usually relates to a current location of the cursor.

In this embodiment, the at least one link may be one link or multiple links.

In this embodiment, optionally, if the moving direction of the cursor does not point towards the sight focus area, there may be no need for the link determining module 22 to determine the at least one link within the sight focus area, and further, there may be no need for the acquiring module 23 to acquire at least one piece of content corresponding to the at least one link.

In this embodiment, each of the at least one link points to an address of a piece of content corresponding to the link.

In this embodiment, the at least one piece of content comprises at least one of the following: at least one web page, at least one application program, at least one document, at least one audio, at least one video, and at least one image.

In this embodiment, an objective of that the acquiring module 23 acquires at least one piece of content corresponding to the at least one link is to be able to open the at least one piece of content faster when a user subsequently needs it. Specifically, the acquiring module 23 may perform acquisition in various manners. Specifically, the acquiring module 23 may be configured to download the at least one piece of content to a local disk from an external device, or load the at least one piece of content to a local memory, or load the at least one piece of content to the local memory from the local disk.

The content acquiring apparatus embodiments, through determining a sight focus area of a user in a display interface, determining at least one link within the sight focus area in response to a moving direction of a cursor in the display interface towards the sight focus area, and acquiring at least one piece of content corresponding to the at least one link, provides a solution for content acquisition, and pre-acquires content corresponding to the link before a user clicks the link, thereby accelerating opening of corresponding content after the user clicks the link. Moreover, the content is pre-acquired only when the conditions on the sight focus area and the moving direction of the cursor are both met, so that meaningless pre-acquiring may be reduced to some degree.

A content acquiring apparatus 200 of the embodiments is further described through the following optional implementation manners.

In the embodiments, there may be multiple human-computer interaction manners, that is, a user may have multiple ways to control the cursor, specifically, controlling a movement of the cursor.

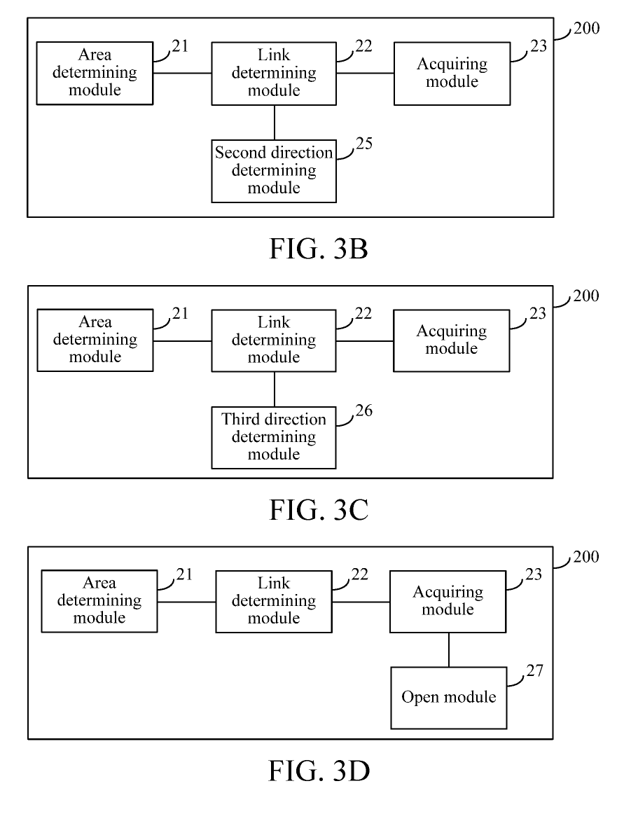

In an optional implementation manner, a user controls the cursor through a mouse. In this implementation manner, optionally, as shown in FIG. 3A, the content acquiring apparatus 200 further comprises:

a first direction determining module 24, configured to determine a moving direction of the cursor in response to at least one mouse operation.

The at least one mouse operation refers to at least one operation to a mouse, comprising but not limited to: moving the mouse, rolling a wheel of the mouse, and the like.

In still another optional implementation manner, a user controls the cursor through touch control. In this implementation manner, optionally, as shown in FIG. 3B, the content acquiring apparatus 200 further comprises:

a second direction determining module 25, configured to determine the moving direction of the cursor in response to a movement of at least one conductor on a touch sensing apparatus.

The at least one conductor may be a limb of a user, such as a finger, or a capacitive pen.

Optionally, the touch sensing apparatus is a touch screen that presents the display interface.

Optionally, the touch sensing apparatus is a touch panel.

In still another optional implementation manner, a user controls the cursor through a body movement. In this implementation manner, optionally, as shown in FIG. 3C, the content acquiring apparatus 200 further comprises:

a third direction determining module 26, configured to determine a moving direction of the cursor in response to at least one body movement of the user.

Optionally, the at least one body movement comprises but is not limited to: at least one hand gesture.

In still another optional implementation manner, a user controls the cursor through a keyboard operation. In this implementation manner, optionally, the content acquiring apparatus 200 further comprises:

a fourth direction determining module, configured to determine a moving direction of the cursor in response to at least one keyboard operation.

The at least one keyboard operation refers to at least one operation to a keyboard, comprising but not limited to: clicking at least one direction key, and the like. Specifically, the at least one direction key comprises but is not limited to at least one of the following: “↑” key, “↓” key, “←” key, and “→” key.

In this embodiment, optionally, as shown in FIG. 3D, the content acquiring apparatus 200 further comprises:

an open module 27, configured to open, in response to that one link in the at least one link is clicked, a piece of content corresponding to the link that has been acquired by the acquiring module 23.

For example, if a piece of content corresponding to the link is a web page, the open module 27 opens the web page in response to that the link is clicked; if a piece of content corresponding to the link is an application program, the open module 27 opens the application program in response to that the link is clicked; if a piece of content corresponding to the link is a document, the open module 27 opens the document in response to that the link is clicked; if a piece of content corresponding to the link is an audio, the open module 27 opens the audio in response to that the link is clicked; if a piece of content corresponding to the link is a video, the open module 27 opens the video in response to that the link is clicked; and if a piece of content corresponding to the link is an image, the open module 27 opens the image in response to that the link is clicked.

Optionally, an open module 27 is specifically configured to display, in response to that one link in the at least one link is clicked, the piece of corresponding to the link content that has been acquired by the acquiring module 23 in the display interface. For example, if the piece of content corresponds to the link is a web page, the open module 27 displays the web page in the display interface in response to that the link is clicked.

In an application scenario of this embodiment, a user opens a browser and enters an image search page. After a key word is inputted, many thumbnails of many images appear in the display interface. Each thumbnail of each image actually is a link corresponding to the image. The user notices one thumbnail among many thumbnails. If the user wants to see an image corresponding to the thumbnail, during a process of moving the mouse, the content acquiring apparatus 200 determines the sight focus area, that is an area where the thumbnail is located, of the user, determines the thumbnail within the sight focus area in response to a moving direction of a cursor in the display interface towards the sight focus area, and acquires an image corresponding to the thumbnail. Later, when the user clicks the thumbnail, the image corresponding to the thumbnail can be opened very quickly.

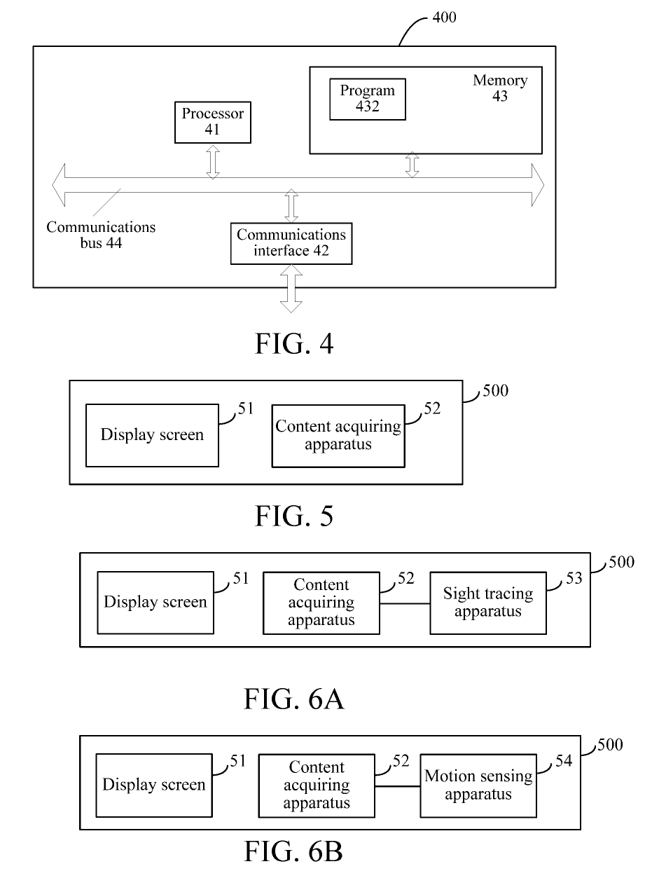

FIG. 4 is a schematic structural diagram of Embodiment 2 of a content acquiring apparatus provided by this application. As shown in FIG. 4, the content acquiring apparatus 400 comprises:

a processor (processor) 41, a communications interface (Communications Interface) 42, a memory (memory) 43, and a communications bus 44, where:

the processor 41, the communications interface 42, and the memory 43 accomplish communication among each other through the communications bus 44.

The communications interface 42 is configured to communicate with an external device.

The processor 41 is configured to execute a program 432, and specifically may execute related steps in the embodiments of the foregoing content acquiring methods.

Specifically, the program 432 may comprise program codes. The program code comprises computer operation instructions.

The processor 41 may be a central processing unit CPU, an application specific integrated circuit ASIC (Application Specific Integrated Circuit), or configured to be one or more integrated circuits to implement the embodiments of the content acquiring method.

The memory 43 is configured to store the program 432. The memory 43 may comprise a high-speed RAM memory, and may further comprise a non-volatile memory (non-volatile memory), for example, at least one magnetic disk storage. The program 432 is specifically used to enable the content acquiring apparatus 400 to perform the following steps:

determine a sight focus area of a user in a display interface;

determine at least one link within the sight focus area in response to a moving direction of a cursor towards the sight focus area; and

acquire at least one piece of content corresponding to the at least one link.

For specific implementation of steps in the program 432, reference may be made to the description of corresponding steps and components in the foregoing embodiments of the content acquiring methods, which is not repeated herein.

For beneficial effects of this embodiment, reference may be made to a description corresponding to embodiments of content acquiring methods provided by this application.

FIG. 5 is a schematic structural diagram of an embodiment of a user equipment provided by this application. As shown in FIG. 5, the user equipment 500 comprises:

a display screen 51, configured to display a display interface; and

a content acquiring apparatus 52 that is described in Embodiment 1 or Embodiment 2 of a content acquiring apparatus provided by this application.

Specifically, the content acquiring apparatus 52 determines a sight focus area of a user in the display interface; determines at least one link within the sight focus area in response to a moving direction of a cursor towards the sight focus area; and acquires at least one piece of content corresponding to the at least one link.

In this embodiment, the user equipment 500 comprises but is not limited any one of the following: a mobile phone, a notebook computer, a tablet, and the like.

For beneficial effects of this embodiment, reference may be made to the description corresponding to Embodiment 1 or Embodiment 2 of content acquiring apparatus provided by this application.

The method of this embodiment is further described through the following optional implementation manners.

In this embodiment, the content acquiring apparatus 52 may use different methods to determine the sight focus area.

In an optional implementation manner, as shown in FIG. 6A, the user equipment 500 further comprises: a sight tracing apparatus 53, configured to trace the sight of the user. Correspondingly, the content acquiring apparatus 52 determines the sight focus area according to a tracing result of the sight tracing apparatus 53.

In the implementation manner, optionally, an area determining module in the content acquiring apparatus 52 is specifically configured to determine the sight focus area according to a tracing result of the sight tracing apparatus.

In this embodiment, there may be multiple human-computer interaction manners between the user equipment 500 and a user, that is, the user may use multiple methods to control the cursor, specifically, controlling a movement of the cursor.

In an optional implementation manner, a display screen 51 is a touch screen. Specifically, the display screen 51 is further configured to sense a movement of at least one conductor on the display screen.

Optionally, the content acquiring apparatus 52 determines a moving direction of the cursor in response to the movement of the at least one conductor that is sensed by the display screen 51. That is, a user can control the cursor through touch on the display screen 51.

In still another optional implementation manner, the user equipment 500 further comprises: a touch panel, configured to sense a movement of at least one conductor on the touch panel.

Optionally, the content acquiring apparatus 52 determines a moving direction of the cursor in response to the movement of the at least one conductor that is sensed by the touch panel. That is, a user can control the cursor through touch on the touch panel.

In still another optional implementation manner, as shown in FIG. 6B, the user equipment 500 further comprises: a motion sensing apparatus 54, configured to acquire at least one body movement of the user.

Optionally, the content acquiring apparatus 52 determines a moving direction of the cursor in response to the at least one body movement that is acquired by the motion sensing apparatus 54. That is, the user may control the cursor through the body movement within an acquisition scope of the motion sensing apparatus 54.

It can be appreciated by a person of ordinary skill in the art that, exemplary units and method steps described with reference to the embodiments disclosed in this specification can be implemented by electronic hardware or a combination of computer software and electronic hardware. Whether these functions are executed by hardware or software depends on specific applications and design constraints of the technical solution. A person skilled in the art may use different methods to implement the described functions for each specific application, but such implementation should not be construed as a departure from the scope of the present application.

If the function is implemented in the form of a software functional unit and is sold or used as an independent product, the product can be stored in a non-transitory computer-readable storage medium. Based on this understanding, the technical solution of the present application essentially, or the part that contributes to the prior art, or a part of the technical solution may be embodied in the form of a software product; the computer software product is stored in a storage medium and comprises several instructions for enabling a computer device (which may be a personal computer, a server, a network device, or the like) to execute all or some of the steps of the method in the embodiments of the present application. The foregoing computer-readable storage medium comprises a U disk, a mobile hard disk, a read-only memory (ROM, Read-Only Memory), a random access memory (RAM, Random Access Memory), a magnetic disk, or an optical disc, or any other medium that can be used for storing program code.

The foregoing implementations are only used to describe the present application, but not to limit the present application. A person of ordinary skill in the art can still make various alterations and modifications without departing from the spirit and scope of the present application; therefore, all equivalent technical solutions also fall within the scope of the present application, and the patent protection scope of the present application should be subject to the claims.

1. A content acquiring method, wherein the method comprises:
determining a sight focus area of a user in a display interface;
determining at least one link within the sight focus area in response to a moving direction of a cursor in the display interface towards the sight focus area; and
acquiring at least one piece of content corresponding to the at least one link.

2. The method of claim 1, wherein after the acquiring at least one piece of content corresponding to the at least one link, the method further comprises:
opening, in response to that one link in the at least one link is clicked, a piece of content corresponding to the link that has been acquired.

3. The method of claim 1, wherein before the determining at least one link within the sight focus area in response to a moving direction of a cursor in the display interface towards the sight focus area, the method further comprises:
determining the moving direction of the cursor in response to at least one mouse operation.

4. The method of claim 1, wherein before the determining at least one link within the sight focus area in response to a moving direction of a cursor in the display interface towards the sight focus area, the method further comprises:
determining the moving direction of the cursor in response to a movement of at least one conductor on a touch sensing apparatus.

5. The method of claim 4, wherein the touch sensing apparatus is a touch screen that presents the display interface.

6. The method of claim 1, wherein before the determining at least one link within the sight focus area in response to a moving direction of a cursor in the display interface towards the sight focus area, the method further comprises:
determining the moving direction of the cursor in response to at least one body movement of the user.

7. The method of claim 6, wherein the at least one body movement comprises: at least one hand gesture.

8. The method of claim 1, wherein the cursor is an explicit cursor or an implicit cursor.

9. The method of claim 1, wherein the at least one piece of content comprises at least one of the following: at least one web page, at least one application program, at least one document, at least one audio, at least one video, and at least one image.

10. A content acquiring apparatus, wherein the content acquiring apparatus comprises:
an area determining module, configured to determine a sight focus area of a user in a display interface;
a link determining module, configured to determine at least one link within the sight focus area in response to a moving direction of a cursor in the display interface towards the sight focus area; and
an acquiring module, configured to acquire at least one piece of content corresponding to the at least one link.

11. The content acquiring apparatus of claim 10, wherein the content acquiring apparatus further comprises:
an open module, configured to open, in response to that one link in the at least one link is clicked, a piece of content corresponding to the link that has been acquired by the acquiring module.

12. The content acquiring apparatus of claim 10, wherein the content acquiring apparatus further comprises:
a first direction determining module, configured to determine a moving direction of the cursor in response to at least one mouse operation.

13. The content acquiring apparatus of claim 10, wherein the content acquiring apparatus further comprises:
a second direction determining module, configured to determine the moving direction of the cursor in response to a movement of at least one conductor on a touch sensing apparatus.

14. The content acquiring apparatus of claim 13, wherein the touch sensing apparatus is a touch screen that presents the display interface.

15. The content acquiring apparatus of claim 10, wherein the content acquiring apparatus further comprises:
a third direction determining module, configured to determine a moving direction of the cursor in response to at least one body movement of the user.

16. The content acquiring apparatus of claim 15, wherein the at least one body movement comprises: at least one hand gesture.

17. The content acquiring apparatus of claim 10, wherein the cursor is an explicit cursor or an implicit cursor.

18. The content acquiring apparatus of claim 10, wherein the at least one piece of content comprises at least one of the following:
at least one web page, at least one application program, at least one document, at least one audio, at least one video, and at least one image.

19. A user equipment, wherein the user equipment comprises:
a display screen, configured to display a display interface; and
a content acquiring apparatus of claim 10.

20. The user equipment of claim 19, wherein the user equipment further comprises: a sight tracing apparatus, configured to trace sight of the user.

21. The user equipment of claim 19, wherein the display screen is a touch screen.

22. The user equipment of claim 19, wherein the user equipment further comprises: a motion sensing apparatus, configured to acquire at least one body movement of the user.

23. A non-transitory computer readable storage medium comprising executable instructions that, in response to execution, cause a device comprising a processor to perform operations, comprising:
determining a sight focus area of a user in a display interface;
determining at least one link within the sight focus area in response to a moving direction of a cursor in the display interface towards the sight focus area; and
acquiring at least one piece of content corresponding to the at least one link.
